(19) United States
(12) Patent Application Publication
(10) Pub. No.: US 2014/0136579 A1
(43) Pub. Date: May 15, 2014

(54) FILE STORING METHOD, AND STORAGE MEDIUM, COMPUTER SYSTEM USABLE FOR THE FILE STORING METHOD

(71) Applicant: GENUSION INC., Hyogo (JP)

(72) Inventor: Moriyoshi NAKASHIMA, Hyogo (JP)

(73) Assignee: GENUSION INC., Hyogo (JP)

(21) Appl. No.: 14/080,293

(22) Filed: Nov. 14, 2013

(30) Foreign Application Priority Data
Nov. 12, 2012 (JP) 2012248831

(51) Int. Cl. G06F 17/30

(52) U.S. Cl. CPC G06F 17/30218
USPC 707/824

(57) ABSTRACT

Provided is a storage media, including a nonvolatile semiconductor storage device, from which data is erasable with certainty on a file-by-file basis so that files leaks are prevented to a maximum possible degree. In a file storing method for storing a file in the storage media including a nonvolatile semiconductor storage device having a plurality of erase blocks each including a plurality of memory cells from which data is erasable as a whole, (a) one file is stored to one erase block, or (b) an overwrite operation of writing prescribed data or random data to a bit of a memory cell, at which a file to be erased is stored, is performed.

### CROSS REFERENCE TO RELATED APPLICATION

This application is based upon and claims the benefit of priority from the prior Japanese Patent Application No. 2012-248831, filed on Nov. 12, 2012; the entire contents of which are incorporated herein by reference.

### BACKGROUND OF THE INVENTION

1. Field of the Invention

The present invention relates to a storage medium including a nonvolatile semiconductor storage device, a file storing method using for the same, and a computer system and a device driver used for carrying out the file storing method.

2. Description of the Related Art

Conventionally, files created by a personal computer or the like are mainly stored on a USB memory or the like including a NAND flash memory. However, a USB memory or the like may be possibly lost. In the case where a file stored thereon includes sensitive information such as private information or the like or business secrets which need to be kept strictly confidential, a serious business loss may be incurred if such a USB memory is lost. In order to avoid such a loss, files are manually erased based on certain criteria, or software including an algorithm for erasing files at certain timings is installed on a personal computer.

For storing a file on a USB memory or the like including a NAND flash memory, a storage area is divided into a data area and a file management area. For erasing a file from a USB memory or the like including a NAND flash memory, the file management area is flagged so that it is merely considered that the corresponding file is “erased”. This merely causes a situation where when the medium such as the USB memory or the like is formatted, the management area is erased and a start address of the file in the data area cannot be specified, which makes it difficult to read the file. In order to erase the file so as not to be recoverable, fixed data such as FF or 00 needs to be written in the entire data area. Software for this purpose is known.

In such circumstances, a storage medium which allows data to be erased therefrom with certainty on a file-by-file basis and a file erasing method used for such a storage medium are desired.

The present applicant has proposed a B4 flash memory, which is a large capacity nonvolatile semiconductor storage medium capable of replacing a NAND flash memory. The B4 flash memory provides a significantly larger number of cycles of write and erase than the NAND flash memory, allows data to be written or erased in a shorter time, and requires only a small total power consumption for a write operation and an erase operation. A method for improving security which is preferable for the B4 flash memory and makes maximum use of the characteristics thereof has been studied.

Patent Document 1: Japanese Laid-Open Patent Publication

### SUMMARY OF THE INVENTION

The present invention has an object of providing a storage medium, including a nonvolatile semiconductor storage device, from which data is erasable with certainty on a file-by-file basis so that file leaks are prevented to a maximum possible degree, and a file storing method using for the same, and a computer system and a device driver used for carrying out the file erasing method.

In a file storing method in an embodiment according to the present invention for storing a file on a nonvolatile semiconductor storage device including a plurality of erase blocks each including a plurality of memory cells from which data is erasable as a whole, only one file is stored to one erase block.

In the file storing method, only one file may be stored to one erase block or only one file may be stored to a plurality of erase blocks in accordance with an instruction from a host-side element.

In a file storing method in another embodiment according to the present invention for storing a file on a nonvolatile semiconductor storage device including a plurality of erase blocks each having a plurality of memory cells from which data is erasable as a whole, an overwrite operation of writing prescribed data or random data to a bit of a memory cell, at which a file to be erased is stored, is performed.

In another embodiment according to the present invention, a storage medium including a control unit for performing the file storing method, a computer system for supplying a control signal for performing the file storing method, and driver software for generating such a control signal are provided.

The present invention provides a storage medium, including a nonvolatile semiconductor storage device, from which data is erasable with certainty on a file-by-file basis so that file leaks are prevented to a maximum possible degree.

### BRIEF DESCRIPTION OF DRAWINGS

FIG. 1 is a cross-sectional view showing a structure of a memory cell for performing a B4 write operation.

FIG. 2 is a circuit diagram of a memory cell array including memory cells for performing a B4 write operation.

FIG. 3 is a block diagram of a B4 memory die.

FIG. 4 is a schematic view of a package including a plurality of B4 memory dies.

FIG. 5 shows the relationship among banks, blocks and pages in one die.

FIG. 6 shows a flow of file storing in Embodiment 1 according to the present invention.

FIG. 7 shows a flow of file storing in Embodiment 1 according to the present invention.

FIG. 8 shows a flow of file storing in Embodiment 1 according to the present invention.

FIG. 9 shows a flow of file storing in Embodiment 1 according to the present invention.

FIG. 10 shows a flow of file storing in Embodiment 1 according to the present invention.

FIG. 11 shows a flow of file storing in Embodiment 2 according to the present invention.

FIG. 12 shows a flow of file storing in Embodiment 2 according to the present invention.

FIG. 13 is a block diagram showing a circuit configuration of a USB memory according to the present invention.

FIG. 14 is a block diagram showing a configuration of a computer system according to the present invention.

### DESCRIPTION OF EMBODIMENTS

Hereinafter, embodiments for carrying out the present invention will be described. The present invention is not limited to the following embodiments. The embodiments described below may be modified in various ways to carry out the present invention. In this specification, write, erase and destruction of a file are each considered as a method of storing a file.

### (Example of B4 Flash Memory)

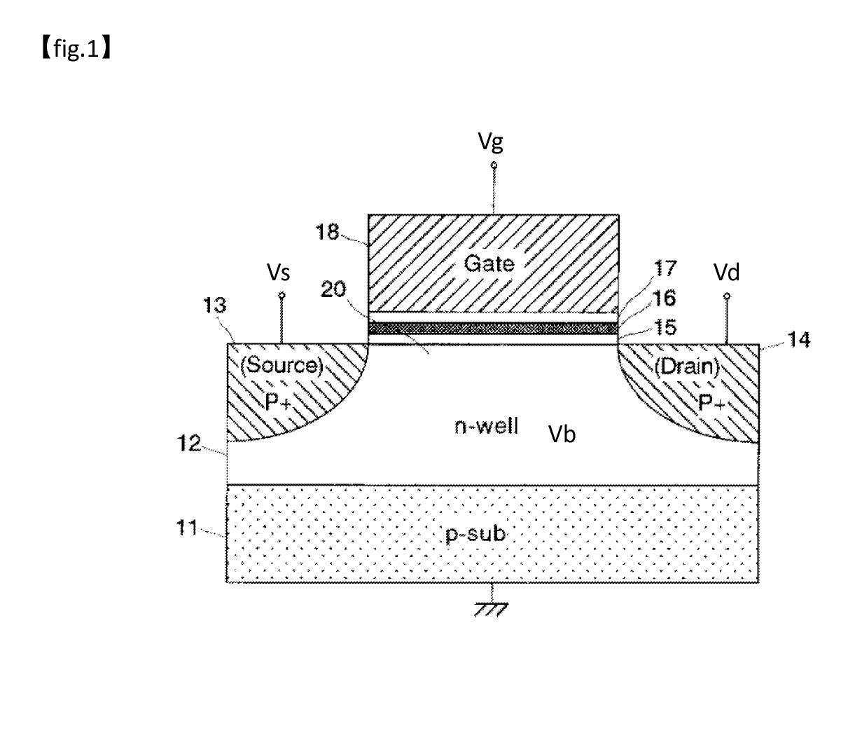

FIG. 1 is a cross-sectional view showing a structure of a memory cell of a B4 flash memory used in the present invention. Herein, the “B4 flash memory” refers to a flash memory including a memory cell which includes a p-type MOS transistor that is formed in an n-well and has a charge accumulation area such as, for example, a nitride film or a floating gate. In the B4 flash memory, the voltage relationship at the time of write is Vg, Vb>Vs>Vd (where Vg is a gate voltage, Vb is a substrate bias voltage, Vs is a source voltage, and Vd is a drain voltage), and the value of Vg−Vd is equal to or higher than the voltage at which an inter-band tunnel current is generated.

As shown in FIG. 1, the memory cell according to the present invention is a p-type MOS transistor formed in an n-well 12, which is formed on a p-type semiconductor substrate (p-sub) 11. The p-type MOS transistor includes a source 13 and a drain 14, which are p⁺-type diffused areas separated from each other, and also includes a channel region 20 located between the source 13 and the drain 14. On the channel region 20, an ONO film including an oxide film 15, a nitride film 16 and an oxide film 17 is formed. On the ONO film, a gate 18 formed of polycrystalline silicon doped with impurities is provided. A floating gate may be used instead of the nitride film 16. The nitride film 16 or the floating gate forms a charge accumulation layer. Vg is the voltage to be applied to the gate 18, Vb is the substrate bias voltage, Vs is the voltage to be applied to the source 13, and Vd is the voltage to be applied to the drain 14.

Data is read from the memory cell shown in FIG. 1 as follows. The voltage Vd of about 1 V, the voltage Vb of 1.8 V (equal to the power supply voltage Vcc), the voltage Vs of 1.8 V, and the voltage Vg of, for example, −2.2 V (corresponding to the voltage among a plurality of states in the case of a multi-level cell) are applied. When the threshold value of the memory cell is lower than −2.2 V, a current flows; whereas when the threshold value of the memory cell is higher than −2.2 V, a current does not easily flow. The difference between the threshold value and −2.2 V is detected to determine write data.

Data is written to the memory cell shown in FIG. 1 as follows. The voltage Vd of 0 V, the voltage Vb of 4.5 V, the voltage Vs of 1.8 V, and the voltage Vg of, for example, 7 V are applied. Then, the written data is verified by a verify operation (operation of reading data at a slightly strict condition of, for example, Vg=−3.0 V). The above-mentioned write voltages are applied in repetition until a target threshold value is obtained. Among the write voltages, the voltage Vg is gradually raised each time the write cycle is repeated, and is raised to a maximum of 12 V.

Data is erased from the memory cell shown in FIG. 1 as follows. The voltage Vd is opened, and the voltage Vg is made −10 V and the voltage Vs is made equal to the voltage Vb. The voltage Vs is gradually raised from 7 V. The erase cycle is repeated, and the voltage Vs is raised to a maximum of 12 V. The erase operation is performed on a block-by-block basis.

In the B4 flash memory described above, the length of the channel region between the source and the drain can be shortened to achieve high integration. Both the write operation and the erase operation are performed at a high speed rate, and the write cycle and the erase cycle are performed at a significantly larger number than in a NAND flash memory. Even after a rewrite operation is performed many times, data can be held stably for a long period of time even at a high temperature.

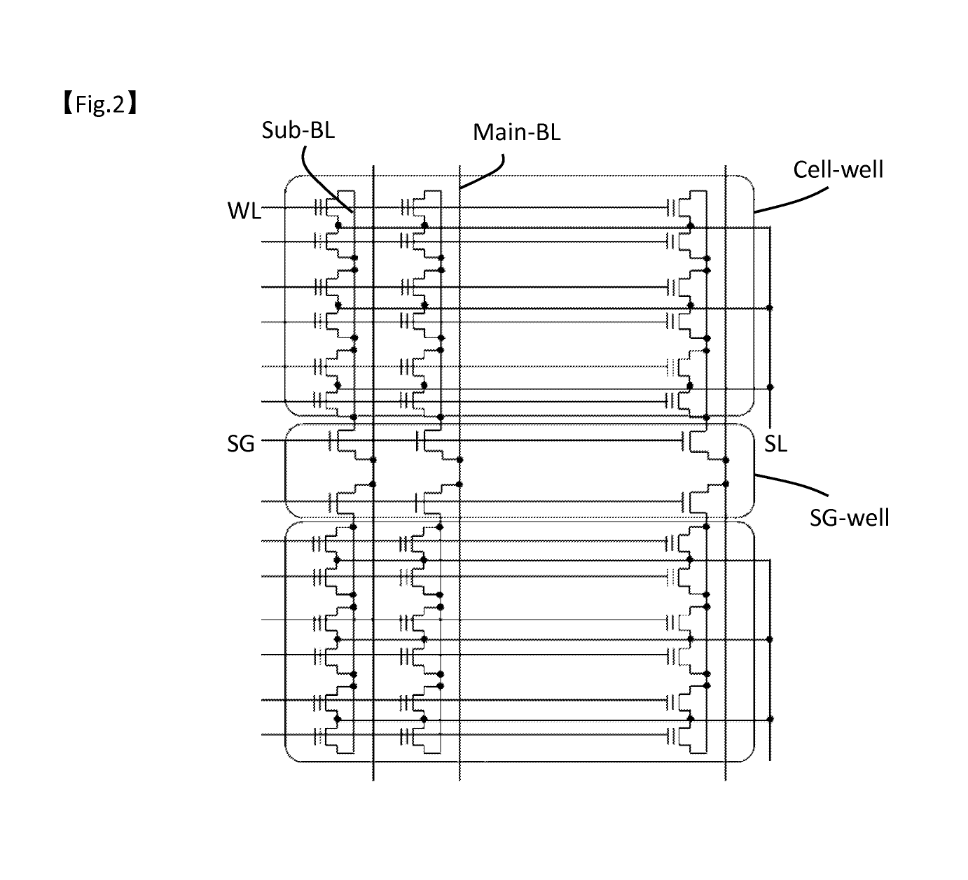

FIG. 2 is a circuit diagram of a memory cell array of the B4 flash memory. In a column direction, n-type cell-wells and p-type select gate wells (SG-wells) are arranged alternately. Each cell-well includes a plurality of p-type memory cells arranged in a matrix. The plurality of memory cells included in each cell-well form a block, which is a unit for data erase. Each cell-well is supplied with the bias voltage Vb. The sources of all the memory cells in each block are commonly connected to a source line SL. The voltage Vs is supplied via the source line SL. In each block, the drains of the memory cells belonging to the same column are commonly connected to a sub bit line (Sub-BL). The voltage Vd is supplied via the sub bit line. Lines extending in a row direction are word lines WL. Gate electrodes of the memory cells belonging to the same row are connected to the same word line WL. The memory cells arranged in each row form a page. The voltage Vg is supplied via each word line. Each select gate well includes a plurality of n-type select gate transistors. Select gate transistors are provided for each column, and each select gate transistor selectively connects a sub bit line and a main bit line corresponding to each other. Gate electrodes of the select gate transistors in the same row are connected to the same select gate line SG.

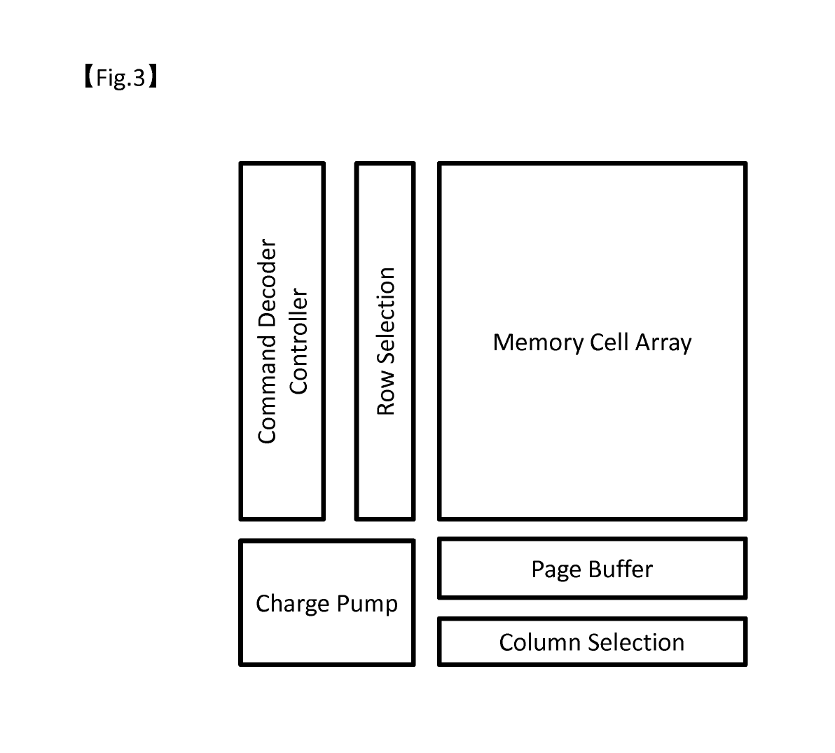

FIG. 3 is a block diagram of a B4 memory die. The B4 memory die includes a row selection circuit for selecting a row of the memory cell array having the circuit shown in FIG. 2, a page buffer for holding data corresponding to one page, namely, one row, a column selection circuit for selecting 16-bit (1-word) data from the data in the page buffer (2-kbit data, i.e., 128-word data), a charge pump circuit for generating and supplying a high voltage, a negative voltage and the like for a write operation, an erase operation or the like, and a command decoder/controller for decoding a command supplied from an external device and controlling various circuits in the B4 memory die.

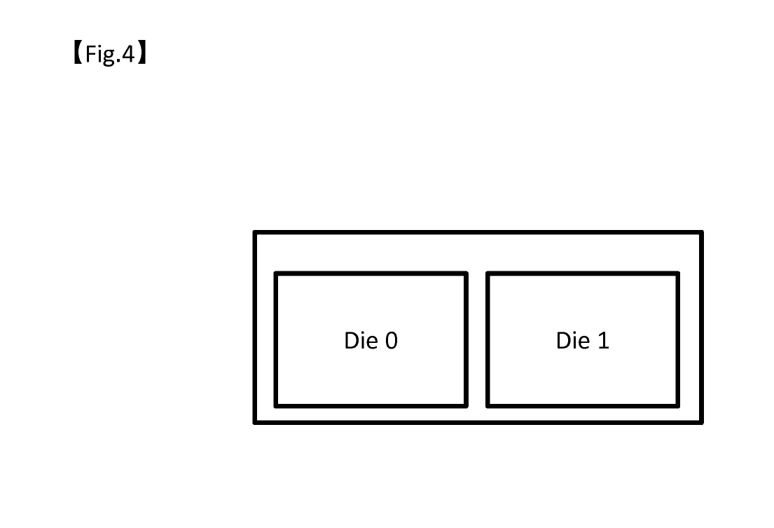

FIG. 4 is a schematic view of a package including a plurality of B4 memory dies. In the example shown in FIG. 4, two dies (Die 0, Die 1) each having a memory capacity of 512 Mbits are enclosed in one package. As a result, the package has a memory capacity of 1 Gbits. The dies respectively include separate chip selection/control signal terminals CE0 and CE1. A multi-level cell (MLC) memory has a memory capacity which is an integral multiple of the memory capacity of the above-described single-level cell (SLC) memory. In the case where, for example, four threshold value states are stored on one memory cell to hold 2-bit data, the capacity of one die is 1 Gbits. One package including two dies has a memory capacity of 2 Gbits.

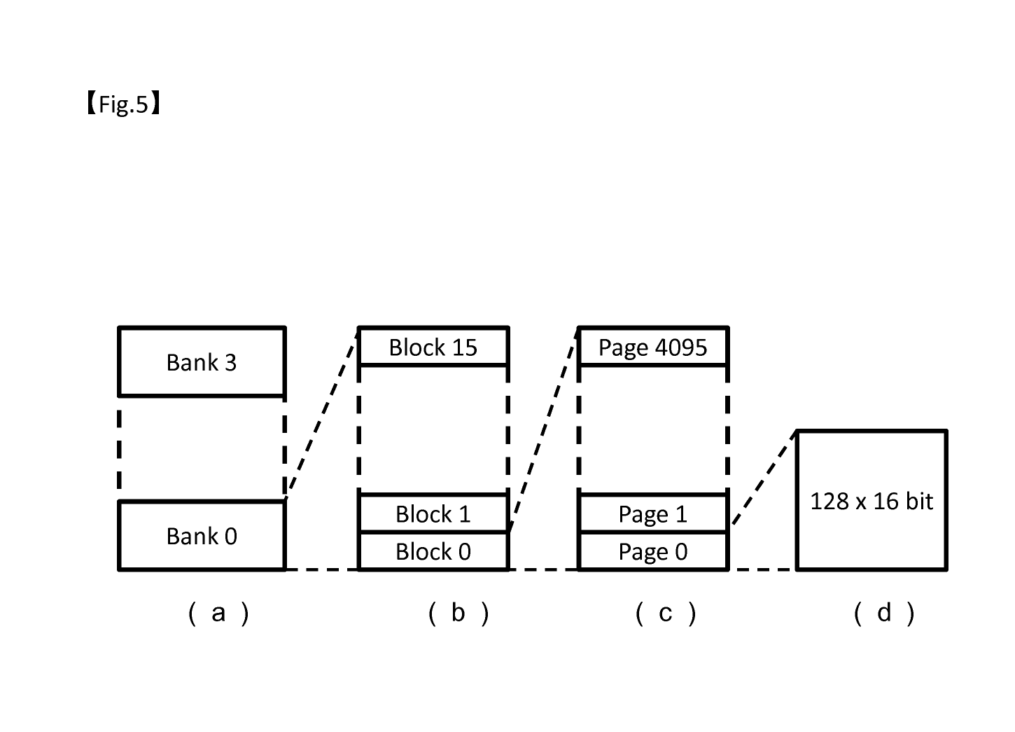

FIG. 5 shows the relationship among banks, blocks and pages in one die. One die includes four banks (Bank 0, Bank 1, Bank 2 and Bank 3). Each bank is divided into 16 blocks (Block 0 through Block 15). Each block is a unit for data erase. Each block is divided into 4096 pages (Page 0 through Page 4095). Each page is a unit for data write. Each page is formed of 2 kbits, namely, 128 words.

### EMBODIMENT 1

### File Storing Method 1 for Improving Security

One through four packages including the B4 flash memories described above form a storage such as a memory card or a USB memory having a capacity of 1 Gb to 8 Gb. Such a storage is connected to a personal computer and is recognized by a user as a drive similar to an HDD or an SSD under the management of an operating system of the personal computer.

A file managed by the operating system is stored on a storage area of the storage. In general, the size of a document file is several ten kilobits to several ten megabits. Therefore, in many cases, a file is stored over a plurality of pages in one or a plurality of blocks. In many cases, a plurality of files is stored in one block.

In a file storing method according to the present invention described below, only one file is stored to one erase block.

### (File Storing Method 1)

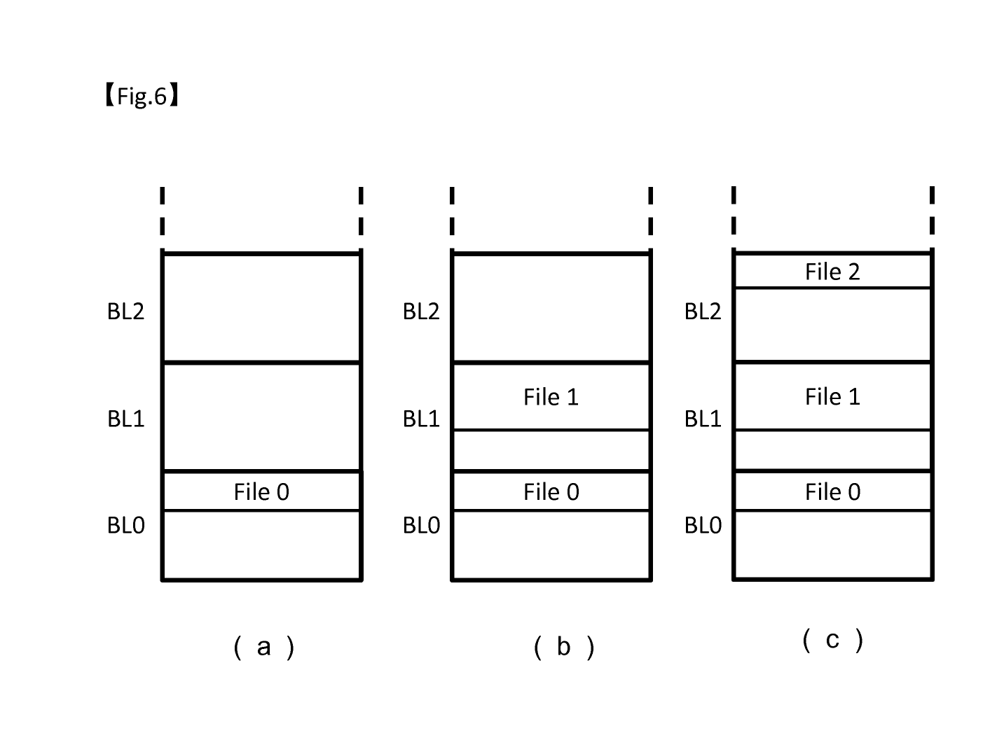

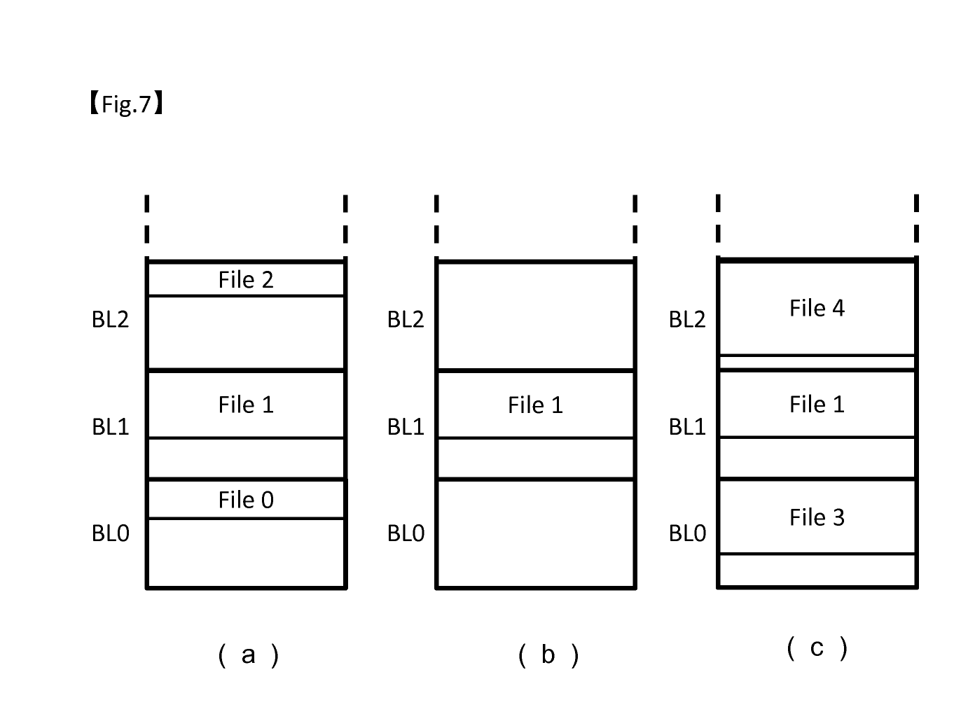

Hereinafter, file storing method 1 will be described with reference to FIG. 6 and FIG. 7. FIG. 6 shows how three files are sequentially stored to three blocks. Referring to FIG. 6(a), when an instruction to write File 0 is issued from the operating system, data of File 0 is written to block BL0. Referring to FIG. 6(b), when a further instruction to write File 1 is issued from the operating system, data of File 1 is written to block BL1, which is a new blank block, instead of block BL0 having the data of File 0 already written therein. Referring to FIG. 6(c), when a still further instruction to write File 2 is issued from the operating system, data of File 2 is written to block BL2, which is a new blank block, instead of block BL0 having the data of File 0 already written therein or block BL1 having the data of File 1 already written therein. In this manner, data of only one file is stored to one erase block.

FIG. 7 shows how the files stored as shown in FIG. 6 are erased and a state after the erase. It is assumed that in a state shown in FIG. 7(a), instructions to erase File 0 and File 2 are sequentially issued from the operating system. Then, as shown in FIG. 7(b), an erase operation is performed on blocks BL0 and BL2. This erase operation is not to merely flag a file management area, but to physically erase the data from the erase blocks. As a result, blocks BL0 and BL2 become blank blocks, namely, are put into a state where data of another file can be written thereto. Referring to FIG. 7(c), when further instructions to write File 3 and File 4 are issued from the operating system, data of File 3 is written to block BL0 and data of File 4 is written to block BL2.

In a structure in which one file is stored to one erase block as described above, a file can be erased by physically erasing the data from the erase block having the file stored therein. This improves security.

### (Write of File Data Over a Plurality of Erase Blocks)

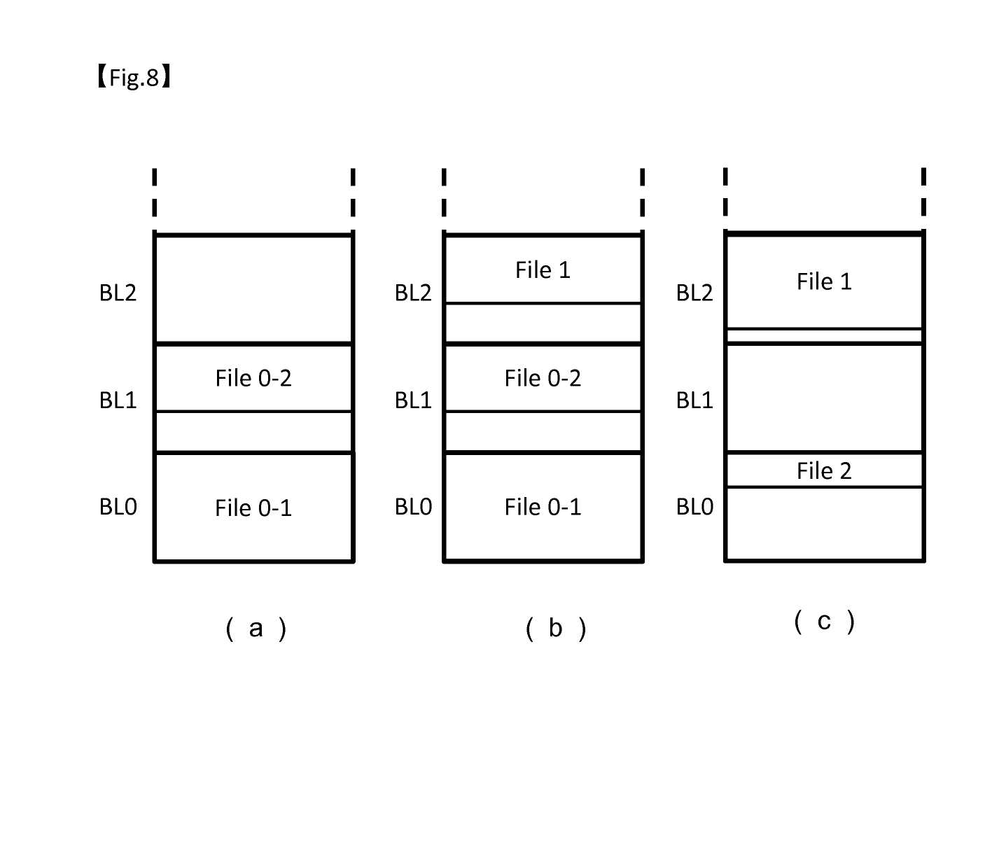

FIG. 8 shows a case where in file storing method 1, the data instructed to be written by the operating system is too large to be accommodated in one block and needs to be accommodated over a plurality of blocks. Referring to FIG. 8(a), when the data of File 0 is too large to be accommodated in one block and needs to be accommodated over two blocks, File 0-1 is written to block BL0 and File 0-2 is written to block BL1. Referring to FIG. 8(b), when an instruction to write File 1 is issued from the operating system, the data of File 1 is written to block BL2, which is a new blank block, instead of the remaining part of block BL1 having data of File 0-2 already written therein. When a further instruction to erase File 0 is issued from the operating system, the data in block BL0 and block BL1 is physically erased and blocks BL0 and BL1 become blank blocks. When a further instruction to write File 2 is issued from the operating system, the data of File 2 is written to, for example, block BL0.

In a structure in which only one file is stored to one erase block as described above, a file can be erased by physically erasing the data from one or a plurality of erase blocks having the file stored therein. This improves security.

### (File Overwrite)

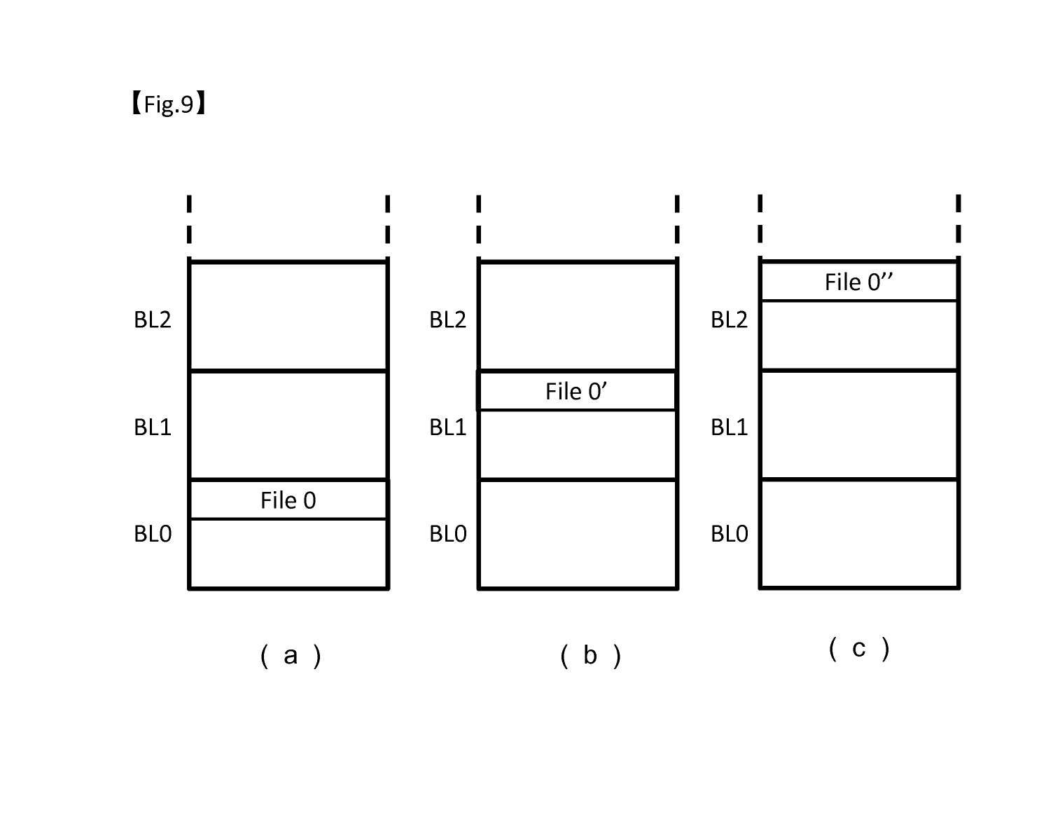

FIG. 9 shows a case where in file storing method 1, an instruction to overwrite a file (instruction to record different content of a file with the same file name) is issued from the operating system. As shown in FIG. 9(a), block BL0 has the data of File 0 written therein. When an instruction to update the content of the data of File 0 is issued from the operating system, data of File 0′, which is the updated file, is written to block BL1, which is a blank block next to block BL0. Concurrently with this operation, the data in block BL0 is physically erased and block BL0 becomes a blank block. When a further instruction to update the content of the data of File 0′ is issued from the operating system, data of File 0″, which is the updated file, is written to block BL2, which is a blank block next to block BL1. Concurrently with this operation, the data in block BL1 is physically erased and block BL1 becomes a blank block.

In a structure in which update of a file is performed by storing an updated file to a different erase block as described above, an erasure operation of the file which is required by the file update can be performed by physically erasing the data from the erase block having the pre-update file stored therein. This improves security.

In a modification of file storing method 1 according to the present invention described below, only one file is stored to one erase block or a plurality of files is stored to one erase block based on an instruction from a host-side element.

### (Modification of File Storing Method 1)

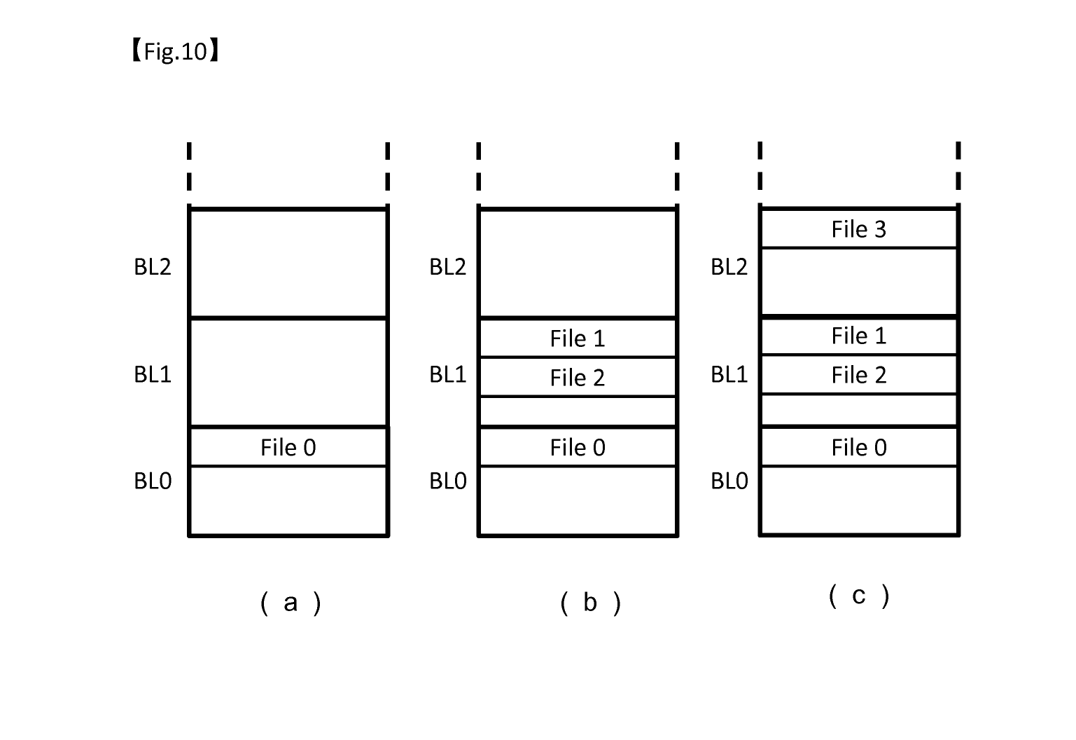

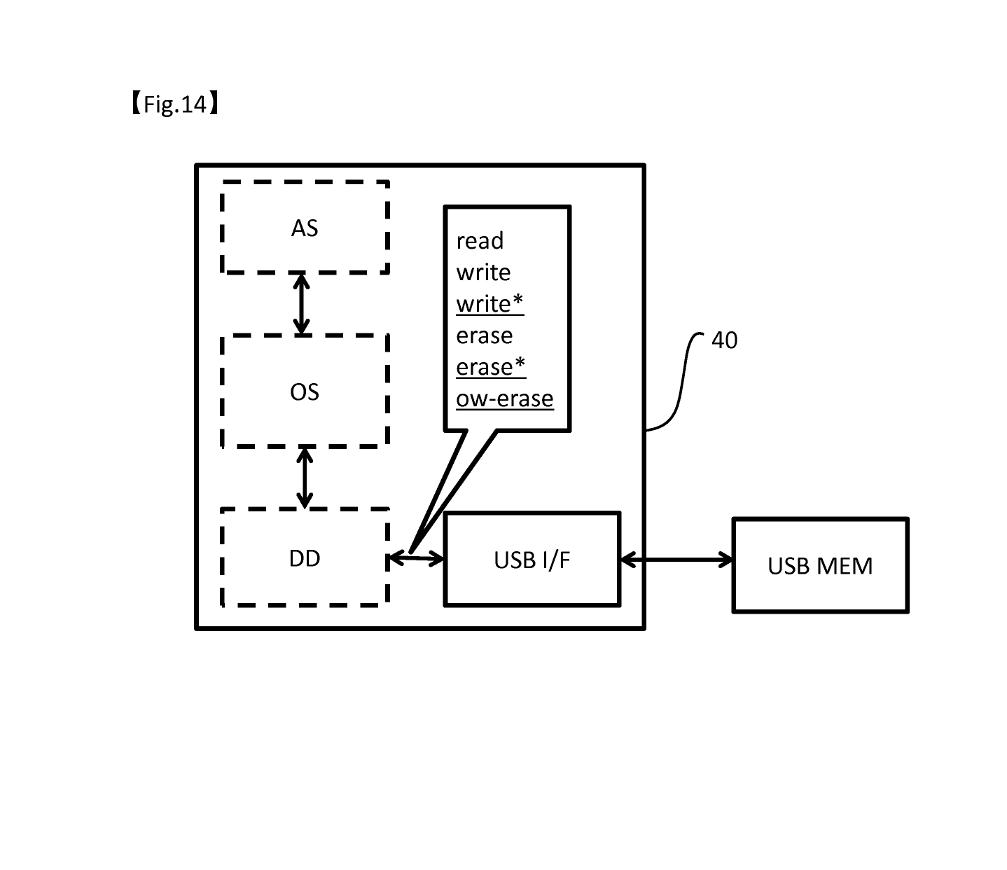

Hereinafter, a modification of file storing method 1 will be described with reference to FIG. 10. In this example, a host-side element (computer system, operating system or device driver) instructs, in each case, normal write (“write” in FIG. 14) which allows writing a plurality of files to one erase block as in the conventional art or block-by-block write (write*) which writes only one file to one erase block. Referring to FIG. 10(a), when an instruction to perform block-by-block write of File 0 is issued from the operating system, the data of File 0 is written to block BL0. Referring to FIG. 10(b), when a further instruction to perform normal write of File 1 is issued from the operating system, the data of File 1 is written to block BL1, which is a new blank block, instead of block BL0 having the data of File 0 already written therein. Still referring to FIG. 10(b), when a further instruction to perform normal write of File 2 is issued from the operating system, the data of File 2 is also written to block BL1 in addition to the data of File 1. Referring to FIG. 10(c), when a further instruction to perform block-by-block write of File 3 is issued from the operating system, the data of File 3 is written to block BL2. In this manner, normal write or block-by-block write can be selectively performed by an instruction from the host-side element. For example, block-by-block write is selected for a file which needs to be protected at a high level of security and thus needs to be physically erased, whereas normal write is selected for other files.

In a structure in which normal write and block-by-block are selectively performed as described above in accordance with the level of security required for protecting each file, a larger number of files can be stored than in a structure in which only block-by-block write is performed.

### EMBODIMENT 2

### File Storing System 2 for Improving Security

In a file storing method according to the present invention described below, data erase is performed by overwriting data at a bit of a memory cell, at which a file to be erased is stored, with prescribed data or random data.

### (File Storing Method 2)

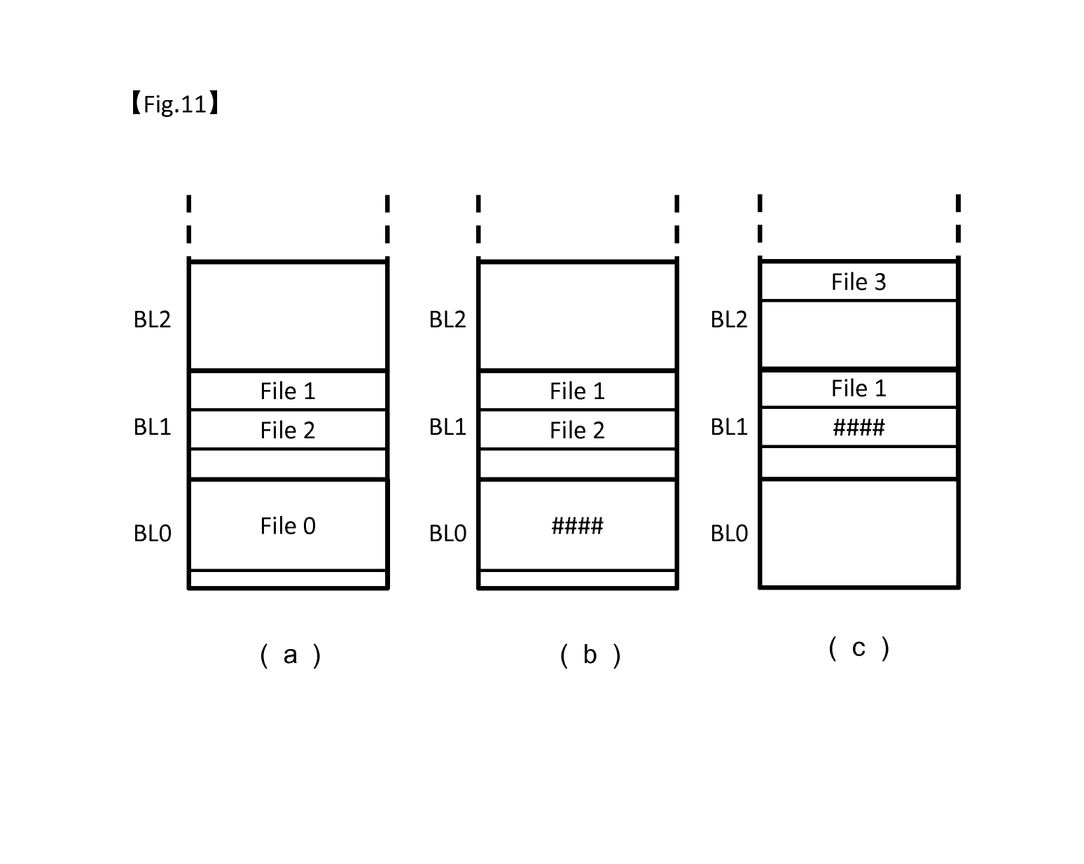

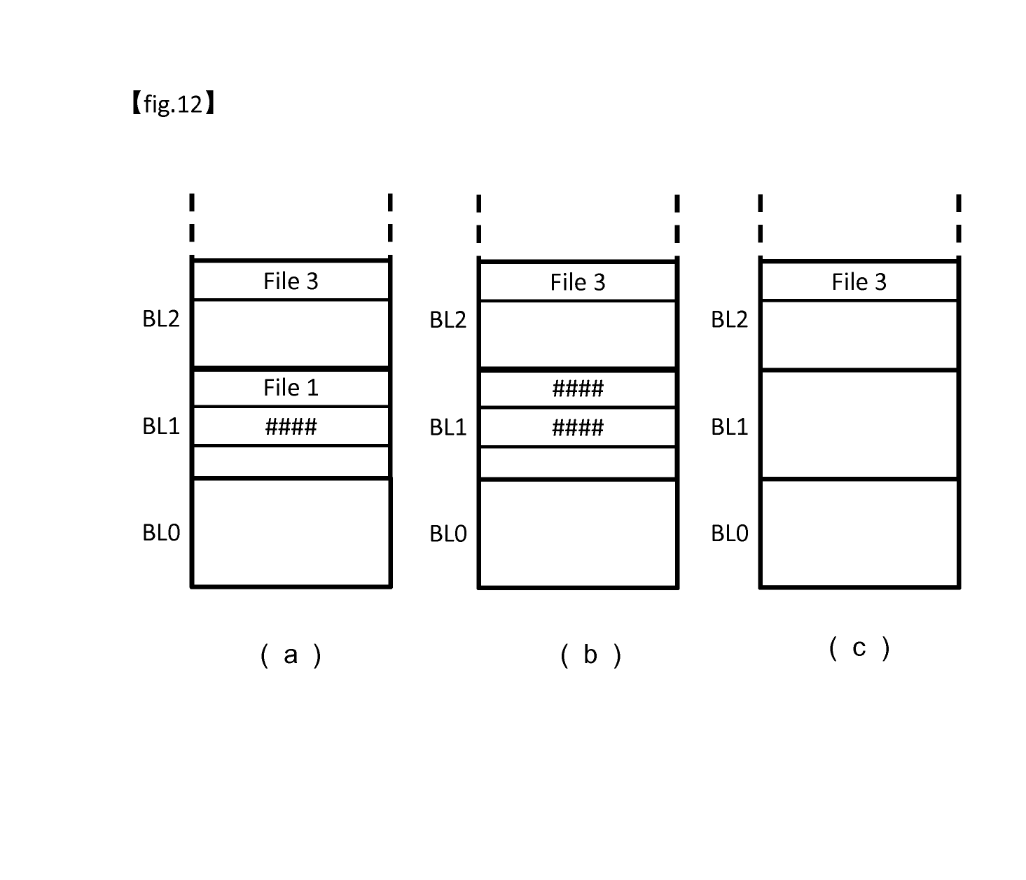

Hereinafter, file storing method 2 will be described with reference to FIG. 11 and FIG. 12. FIG. 11(a) shows a state where block BL0 has the data of File 0 written therein and block BL1 has the data of File 1 and File 2 written therein. Referring to FIG. 11(b), when an instruction to erase File 0 is issued from the operating system, an overwrite operation is performed by which prescribed data or random data is written to an area in block BL0 where the data of File 0 is written. An example of the prescribed data is data in which all the bits correspond to a threshold value distribution farthest from an erase state among the threshold value distributions in the memory cell (state in which a write operation has been performed to a maximum). Such an overwriting operation with the prescribed data or random data destroys the data of the file to be erased, and thus the file to be erased becomes unreadable. Next, the data in block BL0 is physically erased at an appropriate timing. Referring to FIG. 11(c), when a further instruction to erase File 2 is issued from the operating system, an overwrite operation is performed by which prescribed data or random data is written to an area in block BL1 where the data of File 2 is written. As a result, the data of File 2 is destroyed. At this point, the data in block BL1 is not erased (because if the data in block BL1 is erased at this point, the data of File 1 is also erased).

FIG. 12(a) shows a state where the block BL0 is blank and block B1 has the data of File 1 and the destroyed data of File 2 written therein. Block BL2 has the data of File 3 written therein. It is assumed that in this state, an instruction to erase File 1 is issued from the operating system. There are two possible methods for erasing File 1. According to one method, as shown in FIG. 12(b), an overwrite operation is performed by which prescribed data is written to an area in block BL1 where the data of File 1 is written. As a result, the data of File 1 is destroyed. Next, the data in block BL1 is physically erased at an appropriate timing. This results in a state shown in FIG. 12(c) in which block BL1 is blank. According to the other method, the data in block BL1 is erased without performing an overwrite operation of writing the prescribed data to an area in block BL1 where the data of File 1 is written. Namely, when, in the erase block in which the file to be erased is stored, the data other than the file to be erased is entirely destroyed, only physical erase is performed. This saves the time required for destroying the data.

In a structure in which erase of a file is performed by an overwrite operation of writing prescribed data or random data to a bit of a memory cell in which the file to be erased is stored, the data to be erased becomes unreadable. This improves security.

### (System Configuration of the USB Memory and the Host-Side Element)

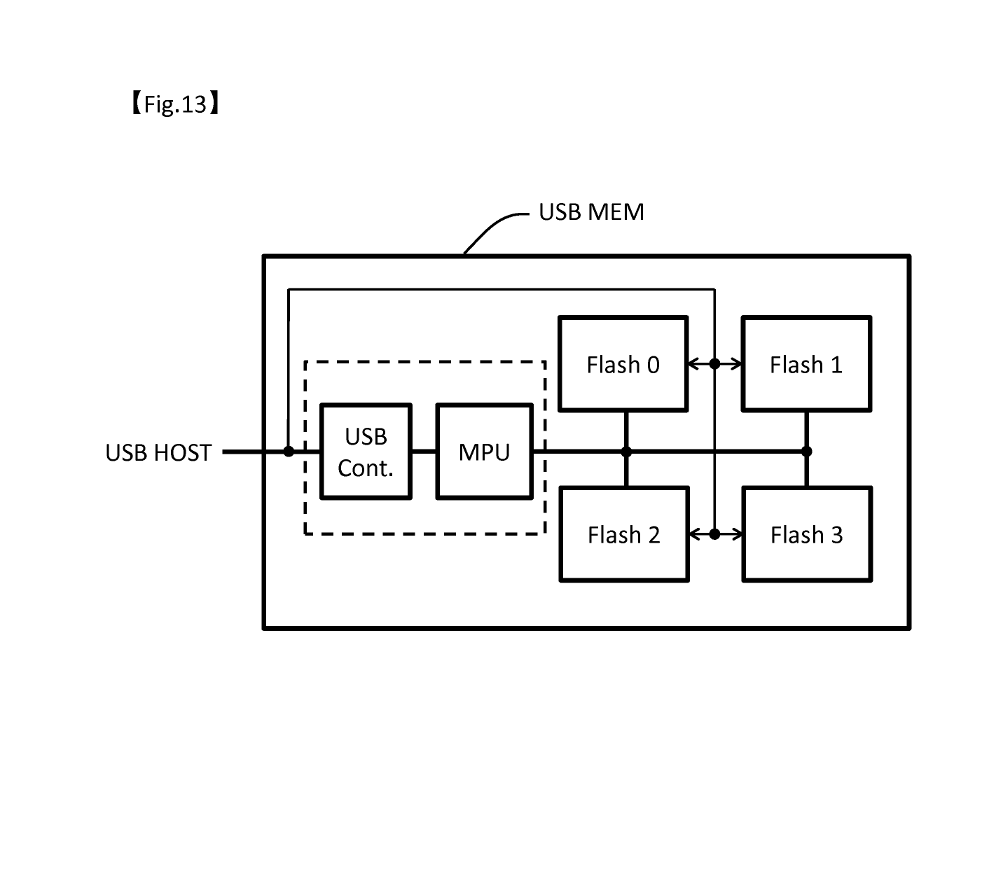

FIG. 13 is a block diagram showing a circuit configuration of a USB memory USB_MEM according to the present invention. The USB memory USB_MEM includes flash memory packages Flash 0 through Flash 3, and a controller chip (enclosed by the dashed line in FIG. 13) including a USB controller and an MPU for controlling the flash memories in one chip.

The controller chip includes a RAM area for converting a logical address transmitted from a USB HOST into a physical address and caching a part of a FAT (File Allocation Table) area or written data. The controller chip performs such control for performing file storing method 1 described above. The commands transmitted from the host-side element are substantially the same as those in the conventional art.

In the modification of file storing method 1 (example in which block-by-block write and normal write are selectively performed), when receiving a block-by-block write command or a normal write command from the USB HOST, the controller chip performs an operation in accordance with the received command.

FIG. 14 is a block diagram of a system configuration of a host-side system 40 connected to the USB memory USB-MEM described with reference to FIG. 13. The system 40 includes a USB interface USB_I/F in addition to a CPU, a main memory, an internal bus and the like which are not shown. The elements shown enclosed by the dashed lines in FIG. 14 are implemented by software, and are application software AS, a device driver DD, and an operating system OS for bridging the application software AS and the device driver DD. Such software elements are loaded onto the main memory and implemented by the CPU. The device driver DD directly controls the USB interface USB_I/F and issues instructions to read, write and erase (namely, generates a control signal corresponding to each of the instructions and supplies the control signal to the USB interface USB_I/F). A read instruction (read), a normal write instruction (write) and a normal erase instruction (erase) of a file are issued conventionally. An instruction group issued by the device driver DD in an embodiment according to the present invention further includes a block-by-block write instruction (write*), a block-by-block erase instruction (erase*), and an overwrite erase instruction (ow-erase).

A block-by-block write instruction (write*) is a write instruction to write data, of the file to be written, to a blank block, namely, a write instruction to record only one file to one erase block so that it is guaranteed that a plurality of files is not written to one block. The normal write instruction (write) is a write instruction with no such guarantee.

A block-by-block erase instruction (erase*) is an erase instruction to physically erase the data of the file to be erased. The normal erase instruction (erase) is an erase instruction to merely rewrite the data in the management area.

An overwrite erase instruction (ow-erase) is an instruction to overwrite data at a bit in a memory cell, at which the file to be erased is stored, with prescribed data or random data.

### (Example in Which a Process is Performed on the USB Memory Side)

FIG. 14 shows an example in which a block-by-block write instruction (write*), a block-by-block erase instruction (erase*), an overwrite erase instruction (ow-erase) are explicitly issued from the host-side element. Alternatively, a process substantially the same as when such an instruction is issued may be performed by the USB memory (USB_MEM). In this case, a block which is a target of a block-by-block write instruction (write*), a block-by-block erase instruction (erase*) or an overwrite erase instruction (ow-erase) is specified by the MPU, shown in FIG. 13, for controlling the flash memories, and a process substantially the same as when such an instruction is issued from the host-side element is performed. Specifically, when an instruction to write data in a FAT (File Allocation Table) area, which is a file management area in which logical positions are fixed, the current state is compared with a state before the instruction to write is issued and the difference between the two states is found. As a result, the area in which the file to be erased is stored is specified. Once such an area is specified, the USB memory USB_MEM can execute a process substantially the same as when a block-by-block erase instruction (erase*) or an overwrite erase instruction (ow-write) is issued.

### OTHER EMBODIMENTS

In the above description, examples in which a B4 flash memory is used as a nonvolatile semiconductor storage medium are shown. Alternatively, a NAND flash memory is may be used as long as block-by-block erase can be performed. In the above description, a USB interface is used as the interface. Alternatively, another type of interface which is connectable to a storage medium, for example, a SATA or the like may be used. In the above description, the device driver issues various types of instructions. Alternatively, an OS (Operating System) may issue the various types of instructions.

What is claimed is:

1. A file storing method comprising storing a file in a nonvolatile semiconductor storage device including a plurality of erase blocks each including a plurality of memory cells from which data is erasable as a whole, wherein only one file is stored to one erase block.

2. A file storing method according to claim 1, wherein only one file is stored to one erase block or only one file is stored to a plurality of erase blocks in accordance with an instruction from a host-side element.

3. A file storing method comprising storing a file in a nonvolatile semiconductor storage device, including a plurality of erase blocks each having a plurality of memory cells from which data is erasable as a whole, wherein an overwrite operation of writing prescribed data or random data to a bit of a memory cell, at which a file to be erased is stored, is performed.

4. A storage medium, comprising a control unit for performing a file storing method according to claim 1.

5. A storage medium, comprising a control unit for performing a file storing method according to claim 2.

6. A storage medium, comprising a control unit for performing a file storing method according to claim 3.

7. A computer system for supplying a control signal for performing a file storing method according to claim 1 to the storage medium.

8. A computer system for supplying a control signal for performing a file storing method according to claim 2 to the storage medium.

9. A computer system for supplying a control signal for performing a file storing method according to claim 3 to the storage medium.

10. Driver software for generating the control signal in claim 5.
